(19) United States
(12) Patent Application Publication
(10) Pub. No.: US 2024/0362494 A1
(43) Pub. Date: Oct. 31, 2024

(54) SYSTEMS AND METHODS FOR TRAINING A MODEM ALGORITHM USING FEDERATED LEARNING

(71) Applicant: Samsung Electronics Co., Ltd., Suwon-si (KR)

(72) Inventor: Mostafa El-Khamy, San Diego, CA (US)

(21) Appl. No.: 18/524,467

(22) Filed: Nov. 30, 2023

Related U.S. Application Data
(60) Provisional application No. 63/498,796, filed on Apr. 27, 2023.

(51) Int. Cl. G06N 3/098

(52) U.S. Cl. CPC G06N 3/098

(57) ABSTRACT

A system and a method are disclosed, the method including receiving, by a first local controller of a first edge device, an input associated with an environment in which the first edge device operates, using a first machine-learning algorithm, determining, by the first local controller, a parameter for a pre-trained modem algorithm of the first edge device based on the input, executing a task on the first edge device based on executing the pre-trained modem algorithm with the parameter, determining a result of executing the task, training the first machine-learning algorithm, generating a first update to the first machine-learning algorithm based on the training, sending the first update to a server, receiving, from the server, a server update to the first machine-learning algorithm, and based on the server update, updating the first machine-learning algorithm.

This application claims priority to and the benefit under 35 U.S.C. § 119 (e) of U.S. Provisional Application No. 63/498,796, filed on Apr. 27, 2023, entitled “SYSTEMS AND METHOD FOR IMPROVING PROPRIETARY MODEM ALGORITHMS VIA FEDERATED LEARNING” the entire disclosure of which is incorporated by reference herein.

### BACKGROUND

### 1. Field

Aspects of embodiments of the present disclosure relate to wireless communications. For example, aspects of embodiments of the present disclosure relate to improved systems and methods for training a modem algorithm using federated learning.

### 2. Description of the Related Art

Modern communications systems (e.g., mobile phones, vehicles, laptops, satellites, and the like), also known as edge devices, may include complex modem algorithms. The modem algorithms may be learning-based algorithms that can be trained and improved by inputting data from the operating environments of one or more edge devices.

The above information disclosed in this Background section is for enhancement of understanding of the background of the present disclosure, and therefore, it may contain information that does not constitute prior art.

### SUMMARY

A modem algorithm may be pre-trained and installed into an edge device at a factory. The modem algorithm may be secured and encrypted at the factory to reduce or prevent the likelihood of unauthorized access to the modem algorithm. Because the modem algorithm is secured and encrypted, it may be difficult to continue to train the modem algorithm based on data collected from actual use. For example, sending data collected from actual use over a network may violate privacy protections for users. Additionally, allowing access to the modem algorithm in an edge device may reveal protected or sensitive (e.g., proprietary) information about the modem algorithm, and may consume bandwidth and power.

To overcome these issues, systems and methods are described herein for training modem algorithms based on data collected from actual use via federated learning while allowing for security of sensitive information and reducing bandwidth and power consumption.

Some embodiments of the present disclosure are directed to an edge device including a pre-trained modem algorithm coupled to a local controller. The local controller may be trained by receiving inputs from the environment in which the edge device operates, and by making resource allocation requests based on the inputs. The local controller may be updated, using reinforcement learning, based on whether a characteristic associated with the resource allocation request is satisfactory (e.g., improved). The local controller may be trained to provide the modem algorithm with parameters based on the inputs from the environment. The parameters may be provided via an interface of the modem algorithm (e.g., an application programming interface (API) of the modem algorithm). The local controller may share its updated controller weights (or gradients of the updated controller weights) with a global server to use in updating other edge devices based on federated learning.

Some edge devices may have full training capabilities. For example, an edge device may include an artificial intelligence (AI) processor, such as a graphics processing unit (GPU), a neural processor unit (NPU), a tensor processor unit (TPU), or another processor that is suitable for fully training a machine-learning model. An edge device having full training capabilities, may be capable of training both a feature-extractor portion and a logic portion of the local controller. Some edge devices may have partial (e.g., limited) training capabilities. For example, an edge device may include only a central processing unit (CPU), and might not include a GPU or other processor that is suitable for fully training a machine-learning model. In some embodiments, an edge device having partial training capabilities may be configured to train only the feature extractor portion of the local controller.

The above approaches improve on previous methods because: (i) application of federated learning on a controller that controls parameters of a modem algorithm, instead of applying federated learning on the modem algorithm directly, allows for the modem algorithm to remain secure and private on the edge device; (ii) sharing training weights (or gradients thereof) of the local controller via federated learning, instead of sharing actual data and sensitive modem algorithm models for centralized training, allows for reduced computation costs (e.g., reduced processing time) and reduced communication costs (e.g., reduced bandwidth consumption) while keeping sensitive user data and edge device data secure and private; and (iii) federated learning based on diverse real-world deployment data collected from selected edge devices allows for continuous improvement of modem algorithms.

According to some embodiments of the present disclosure, a method includes receiving, by a first local controller of a first edge device, an input associated with an environment in which the first edge device operates, using a first machine-learning algorithm, determining, by the first local controller, a parameter for a pre-trained modem algorithm of the first edge device based on the input, executing a task on the first edge device based on executing the pre-trained modem algorithm with the parameter, determining a result of executing the task, training the first machine-learning algorithm, based on the task and the result of executing the task, generating a first update to the first machine-learning algorithm based on the training, sending the first update to an external server, receiving, from the external server, a server update to the first machine-learning algorithm, wherein the server update is created, by the external server, using at least one of the first update and a second update from a second local controller of a second edge device, and based on the server update, updating the first machine-learning algorithm.

The task may include sending a resource allocation request from the first edge device to a base station.

The input may include a channel estimate.

The first edge device may include a processing circuit including a central processing unit (CPU), the training may include updating a first feature extractor associated with the first local controller, and sending the first update may include sending an update associated with the first feature extractor.

The first edge device may include a processing circuit including an artificial intelligence (AI) processor, the training may include updating a first controller logic associated with the first local controller, and sending the first update may include sending an update associated with the first controller logic.

The server update may be created by receiving, by the external server, the first update and the second update, generating aggregated data based on the first update and the second update, and updating a global algorithm associated with a global controller based on the aggregated data.

The updating of the first machine-learning algorithm may include updating at least one of a first feature extractor or a first controller logic.

According to other embodiments of the present disclosure, a first device includes a processing circuit including a first local controller, and a pre-trained modem algorithm communicatively coupled to the first local controller, wherein the processing circuit is configured to receive an input associated with an environment in which the first device operates, use a first machine-learning algorithm to determine a parameter for the pre-trained modem algorithm based on the input, execute a task on the first device based on executing the pre-trained modem algorithm with the parameter, determine a result of executing the task, train the first machine-learning algorithm, based on the task and the result of executing the task, generate a first update to the first machine-learning algorithm based on the training, send the first update to an external server, receive, from the external server, a server update to the first machine-learning algorithm, wherein the server update is created, by the external server, using at least one of the first update and a second update from a second local controller of a second device, and based on the server update, update the first machine-learning algorithm.

The task may include sending a resource allocation request from the first device to a base station.

The input may include a channel estimate.

The processing circuit may include a central processing unit (CPU), the processing circuit may be configured to train the first local controller by updating a first feature extractor associated with the processing circuit, and the sending of the first update may include sending an update associated with the first feature extractor.

The processing circuit may include an artificial intelligence (AI) processor, the processing circuit may be configured to train the first local controller by updating a first controller logic associated with the processing circuit, and the sending of the first update may include sending an update associated with the first controller logic.

The server update may be created by receiving, by the external server, the first update and the second update, generating aggregated data based on the first update and the second update, and updating a global algorithm associated with a global controller based on the aggregated data.

The updating of the first machine-learning algorithm may include updating at least one of a first feature extractor or a first controller logic.

According to other embodiments of the present disclosure, a system includes a first edge device including a processing circuit, and a memory for storing instructions, which, based on being executed by the processing circuit, cause the processing circuit to receive an input associated with an environment in which the first edge device operates, use a first machine-learning algorithm to determine a parameter for a pre-trained modem algorithm based on the input, execute a task on the first edge device based on executing the pre-trained modem algorithm with the parameter, determine a result of executing the task, train the first machine-learning algorithm, based on the task and the result of executing the task, generate a first update to the first machine-learning algorithm based on the training, send the first update to an external server, receive, from the external server, a server update to the first machine-learning algorithm, wherein the server update is created, by the external server, using at least one of the first update and a second update from a second edge device, and based on the server update, update the first machine-learning algorithm.

The task may include sending a resource allocation request from the first edge device to a base station.

The input may include a channel estimate.

The processing circuit may include a central processing unit (CPU), the processing circuit may be configured to train a local controller of the first edge device by updating a first feature extractor associated with the processing circuit, and the sending of the first update may include sending an update associated with the first feature extractor.

The processing circuit may include an artificial intelligence (AI) processor, the processing circuit may be configured to train a local controller of the first edge device by updating a first controller logic associated with the processing circuit, and the sending of the first update may include sending an update associated with the first controller logic.

The updating of the first machine-learning algorithm may include updating at least one of a first feature extractor or a first controller logic.

### BRIEF DESCRIPTION OF THE DRAWINGS

The above and other aspects of the present disclosure will be more clearly understood from the following detailed description of the illustrative, non-limiting embodiments with reference to the accompanying drawings, in which:

FIG. 1 is a block diagram depicting a system for training a modem algorithm, according to some embodiments of the present disclosure;

FIG. 2 is a diagram depicting a machine-learning model associated with one or more edge devices from the system of FIG. 1, according to some embodiments of the present disclosure;

FIG. 3 is a diagram depicting portions of a neural network associated with the one or more edge devices, according to some embodiments of the present disclosure;

FIG. 4 is a flowchart depicting a method for training the modem algorithm, according to some embodiments of the present disclosure; and

FIG. 5 is a block diagram of an electronic device in a network environment, according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the terms “or” and “and/or” include any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The electronic or electric devices and/or any other relevant devices or components according to embodiments of the present disclosure described herein may be implemented utilizing any suitable hardware, firmware (e.g., an application-specific integrated circuit (ASIC)), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

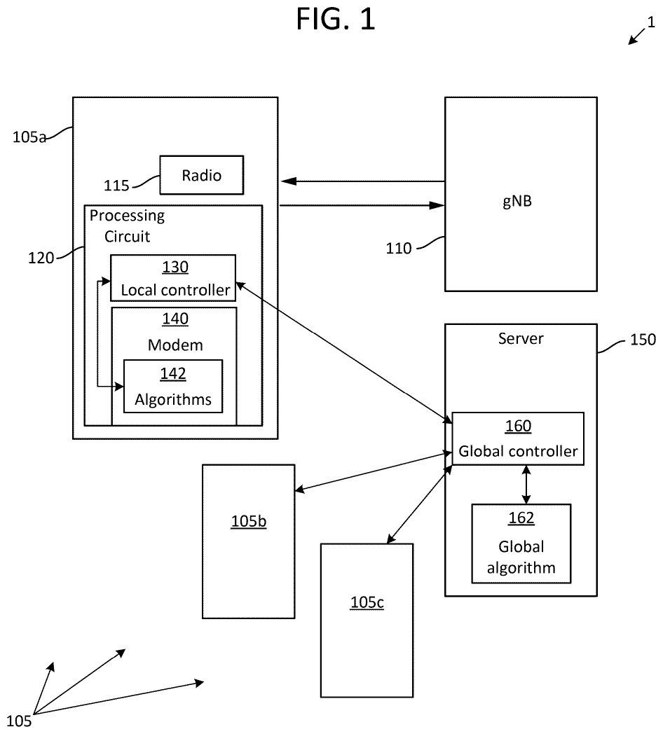

FIG. 1 is a block diagram depicting a system for training a modem algorithm, according to some embodiments of the present disclosure.

As discussed above, communications systems (e.g., mobile phones, vehicles, laptops, satellites, and the like), also known as edge devices, may include complex modem algorithms. The modem algorithms may be learning-based algorithms that can be trained and improved by inputting data from the operating environments of one or more edge devices using federated learning. As used herein, “federated learning” refers to a machine-learning technique involving distributed training of one or more local machine-learning models, which are located remotely from a centralized server, using data that are local to each respective local machine-learning model.

Federated learning has emerged as a commonly used training paradigm in domains where it is prohibited for data to leave the local devices because of sensitivity or privacy. For example, modem designs may include proprietary algorithms, such as channel estimation (CE), channel state information (CSI) prediction, RF frontend adaptation (e.g., digital pre-distortion adaptation, power amplifier adaptation, low noise amplifier adaptation), channel decoding, and location estimation (e.g., using global position system (GPS) or global navigation satellite system (GNSS) signaling, base-station signal strengths, and wireless fidelity (Wi-Fi) signals). With the adoption of fifth generation (5G) wireless standards and millimeter-wave (mm-wave) technology, modem algorithms are becoming more complex. Learning-based algorithms may be used to design more intelligent algorithms for deployment on edge devices (e.g., on mobile SoCs in the edge devices). The ability of learning-based algorithms to improve is limited by the data (e.g., diverse real-world deployment data) available to train these algorithms.

Aspects of some embodiments of the present disclosure use federated learning for improving modem algorithms (e.g., proprietary modem algorithms). This may be done while keeping the proprietary modem algorithms private and secure on the edge devices. Edge devices may utilize diverse channel environments and actual resources observed in the environments where the edge devices are deployed. A controller of an edge device may be trained to provide parameters (e.g., optimized parameters) for the modem algorithms.

Aspects of some embodiments of the present disclosure preserve fairness in machine-learning model training by avoiding bias to a specific scenario (e.g., a specific environment). For example, in some embodiments, a global server tunes (e.g., fine-tunes) global algorithms based on real-world data from users experiencing different scenarios, such as being located indoors and being located outdoors.

The modem algorithms of different edge devices may be improved by using different methods based on the capabilities of a given edge device for training a machine-learning algorithm. For example, some edge devices that include an AI processor, such as a GPU, an NPU, a TPU, or another specialized processor for AI applications, may have full training capabilities to train the weights of the local controller. Some edge devices that include only CPUs may have limited training capabilities and may only be capable of training a feature extractor of the controller. Some edge devices may lack (e.g., totally lack) training capabilities and may provide a low-rank representation (LRR) of their environment.

In some embodiments, an edge device according to the present disclosure may monitor channels and channel states, which are either rarely observed or observed by a minority of users, to allow for continuous, secure, and reliable updates of a global algorithm, and to allow for the deployment of the updates to the global algorithm on edge devices of interest.

Referring to FIG. 1, the system 1 may include one or more edge devices 105 (individually depicted as a first edge device 105a, a second edge device 105b, and a third edge device 105c), a network node 110 (e.g., a gNodeB, also referred to as a “base station”), and a server 150 (e.g., an external server that serves as a global server for federated learning).

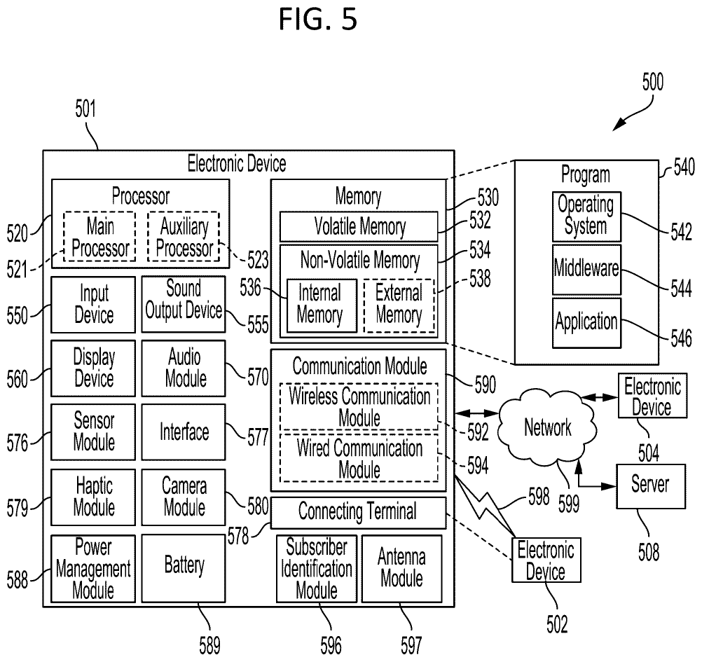

The network node 110 may provide a radio frequency (RF) signal and communication band width to the edge devices 105. The network node 110 may belong to any wireless operator, and may serve many different customers (e.g., may serve devices provided by many different companies) by way of communication standards to allocate resources (e.g., bandwidth, connection speed, and signal-to-noise ratio (SNR)) to different edge devices 105. In some embodiments, the network node 110 may be a satellite (e.g., for providing GPS and/or GNSS signaling), a public Wi-Fi operator, or private Wi-Fi operator. In some embodiments of the present disclosure, the network node 110 may be included in a first network 598 and/or in a second network 599 (e.g., see FIG. 5).

The server 150 may serve fewer customers (e.g., only one customer, or one company) to improve the modem algorithms 142 of a corresponding customer's edge devices 105. For example, the server 150 may be a proprietary server for improving proprietary edge devices 105. The server 150 may correspond to the server 508 (e.g., see FIG. 5).

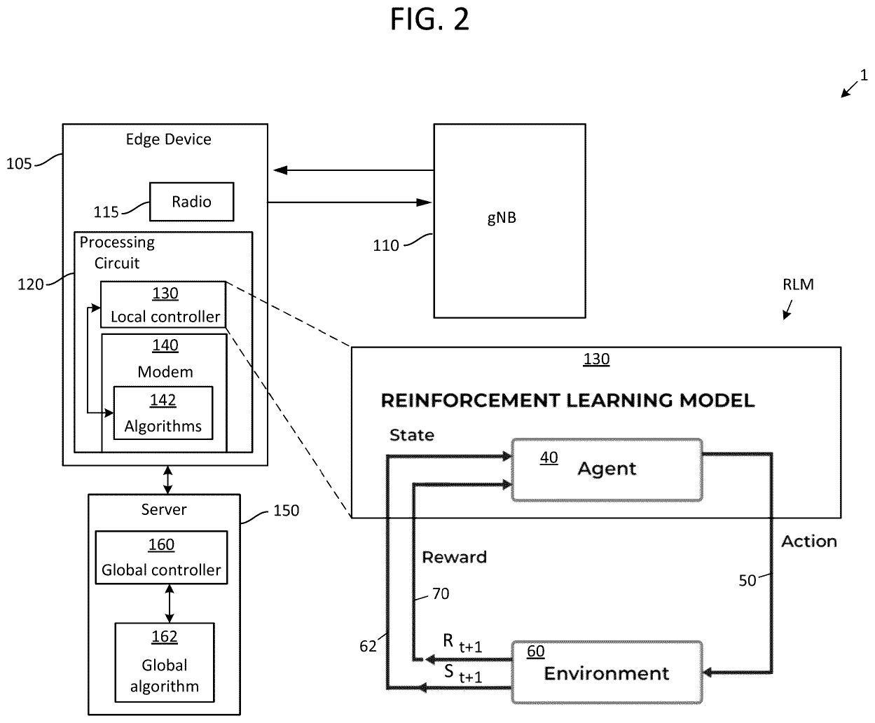

The edge devices 105 may be communicably connected to the network node 110 and to the server 150. As discussed in further detail below with respect to FIG. 2, the edge devices 105 may use information from the network node 110 to train local controllers 130 when participating in a federated learning round. One or more of the edge devices 105 may include a communications device (e.g., a vehicle, a mobile phone, a satellite, a tablet, a personal computer, a navigation device, a game console, and the like). Each of the edge devices 105 may correspond to an electronic device 501 (e.g., see FIG. 5).

One or more of the edge devices 105 (e.g., the first edge device 105a in FIG. 1) may include a radio 115 and a processing circuit 120 (or a means for processing), which may perform various methods described herein. For example, the processing circuit 120 may receive, via the radio 115, transmissions from the network node 110, and the processing circuit 120 may transmit, via the radio 115, signals to the network node 110. The radio 115 may correspond to a wireless communication module 592 (e.g., see FIG. 5). The radio 115 may include an antenna module 597 (e.g., see FIG. 5). The processing circuit 120 may correspond to a processor 520 (e.g., see FIG. 5).

For example, in some embodiments, the processing circuit 120 may include one or more processors and memory. Each of the processors may be a general-purpose processor or specific purpose processor, an application specific integrated circuit (ASIC), one or more field programmable gate arrays (FPGAs), a group of processing components, or other suitable processing components. Each of the processors may be integrated within a single device or distributed across multiple separate systems, servers, or devices (e.g., computers). For example, each of the processors may be an internal processor with respect to the edge devices 105, or one or more of the processors may be an external processor implemented as part of one or more servers or as a cloud-based computing system. Each of the processors may be configured to execute computer code or instructions stored in the memory, and/or received from other computer readable media (e.g., CD-ROM, network storage, a remote server, and/or the like).

The memory may include one or more devices (e.g., memory units, memory devices, storage devices, and/or the like) for storing data and/or computer code for performing and/or facilitating the various processes described in the present disclosure. The memory may include random access memory (RAM), read-only memory (ROM), hard drive storage, temporary storage, non-volatile memory, flash memory, optical memory, or any other suitable memory for storing software objects and/or computer instructions. The memory may include database components, object code components, script components, and/or any other kinds of information structures for supporting the various activities and information structures described in the present disclosure. The memory may be communicably connected to the one or more processors via the processing circuit 120, and may include computer code for executing (e.g., by the one or more processors or processing circuits) one or more processes described herein.

One or more of the edge devices 105, (e.g., the first edge device 105a) may include a modem 140 and a local controller 130. The modem may include, or may operate according to, one or more modem algorithms 142. The local controller 130 may be communicably coupled with the modem algorithms 142. For example, the local controller 130 may be coupled with the modem algorithms 142 by an API for the modem algorithms 142. The API may allow different parameters for the modem algorithms 142 to be changed. The local controller 130 may include one or more machine-learning models. The local controller 130 may be trained to select (e.g., to optimize) and to provide parameters to the modem algorithms 142. The local controller 130 may be capable of training weights. The edge devices 105 may share updated local-controller weights with the server 150. The updated local-controller weights (also referred to as “updates”) may be generated based on training the local controller 130. In some embodiments, one or more of the edge devices 105 may share gradients associated with the updated local-controller weights with the server 150. As used herein, a “gradient” of a given weight of the local controller 130 is a change in the given weight of the local controller 130. That is, an update to a machine-learning algorithm that is implemented by the local controller 130 may be generated based on the training of the local controller 130. In some embodiments, the update may include a newly trained version of the machine-learning algorithm that is implemented by the local controller 130. In some embodiments, the update may include one or more changes to the machine-learning algorithm that is implemented by the local controller 130.

The server 150 may have administrative privileges to select proprietary edge devices 105 to participate in a federated learning round, and to aggregate the updates to the controller weights from the edge devices 105 (e.g., from selected ones of the edge devices). In some embodiments, the server 150 may provide the aggregated updates to a global controller 160 in a federated learning setting. For example, the global controller 160 may identify which edge devices 105 to request data from (e.g., the updates to the controller weights). The global controller 160 may aggregate the data from the edge devices 105. In some embodiments, the aggregation of the data may include determining an average (e.g., a simple average or a weighted average) based on the data from the edge devices 105.

The global controller 160 may update a global algorithm 162 by adjusting tunable parameters of the global algorithm 162. The tunable parameters may correspond to the modem algorithms 142 secured on the edge devices 105. The global controller 160 may share the updated global algorithm 162 with one or more of the edge devices 105. For example, the updated global algorithm 162 may include an updated version of the local controller 130, which has been improved based on the learning experiences of the edge devices 105. As one example, aspects of some embodiments of the present disclosure may be applied to train edge devices 105 to get faster download speeds. For example, an edge device 105 may be trained to get faster downlink speeds and/or faster uplink speeds based on given characteristics of the environment, such that throughput may be improved or maximized. As another example, aspects of some embodiments of the present disclosure may be applied to train edge devices 105 to solve computer vision problems more efficiently, for example, by using data more efficiently to improve image classification, such as allowing a vehicle to recognize pedestrians.

Because only the updated weights (or gradients thereof) of the local controllers 130 are shared over the network (e.g., the secured network) including the edge devices 105 and the server 150, the modem algorithms 142 may be kept private and secure on their respective edge devices 105. By not sharing the actual data, and instead only sharing training weights of the trained (also referred to as “learned”) controller, privacy concerns related to users and edge-devices may be reduced (e.g., eliminated). For example, actual data associated with the edge devices 105 may remain anonymous because the locations of the edge devices 105, and their associated actual channel and state information, cannot be inferred based on either the weights or the gradients of the weights. By not sharing the weights and network architectures of the modem algorithms 142, the modem algorithms 142 may remain hidden, apart from the user interface (UI). Accordingly, the modem algorithms 142 may be hidden in a secure encrypted black box that is secure against unauthorized device access attempts (e.g., physical device hacks).

In some embodiments, the server 150, may select (e.g., randomly select) subsets of the edge devices 105, and may probe the weights of the selected edge devices 105 over a given time frame to save power that might otherwise be unnecessarily consumed. Without selecting subsets of edge devices 105, the server 150 could be asked to collect data from potentially millions of users sharing the weights or training gradients of their respective local controllers 130, which may be trained over long periods of time (e.g., one or more weeks). In some embodiments, the server 150 may choose to update only a subset of edge devices 105. For example, the server 150 may select some edge devices 105 for updating based on geography or based on device capabilities before pushing an updated global algorithm 162 to additional (e.g., to all) edge devices 105. This selective updating may provide a gradual rollover and/or to compare modem algorithms before and after the updates.

The processing circuits 120 of some edge devices 105 may include a GPU (or another processor that is specialized for training AI models) and, thus, may include full capabilities to train their respective local controllers 130. The processing circuits 120 of other edge devices 105 may include only a CPU that is not specialized for training AI models and, thus, may have limited capabilities to train their respective local controllers 130.

FIG. 2 is a diagram depicting a machine-learning model associated with one or more edge devices from the system of FIG. 1, according to some embodiments of the present disclosure.

Referring to FIG. 2, some edge devices 105 may be capable of training (e.g., fully training) the local controller 130 based on reinforcement learning. As used herein, “reinforcement learning” refers to a machine-learning technique, where an agent 40 (e.g., a machine-learning model) takes an action 50 (e.g., an update to one or more weights associated with the machine-learning model) in an environment 60 to improve or maximize a reward 70. The action 50 may change a state 62 associated with the environment 60 to improve or increase the reward 70 achieved with respect to a state 62 (e.g., a previous state) of the system 1 in association with the environment 60. Based on reinforcement learning, the edge device 105 may discover the actions 50 that maximize the reward 70 associated with any given state 62.

In some embodiments, the local controller 130 may include a machine-learning model. The edge device 105 may refine weights of the local controller 130 using new local data corresponding to the environment associated with the edge device 105 and/or the network node 110. For example, the local controller 130 may correspond to the agent 40 of a reinforcement learning model RLM. The local controller 130 may observe (e.g., receive data associated with) the environment 60. The network node 110 may provide a channel for the edge device 105 to transmit and receive data. The environment 60 may include information associated with the channel. For example, the environment 60 may include channel estimates. In other words, the local controller 130 may observe the environment 60 by receiving an input (e.g., data) associated with the environment 60. In some embodiments, the input may include data associated with a channel (e.g., a channel estimate).

The local controller 130 may provide an action 50 including one or more proposed parameters (or arguments) associated with a modem algorithm 142. For example, the proposed parameters associated with the action 50 may include a channel index, a channel type, a Doppler shift, a received signal-strength indicator (RSSI), a codebook, an RF band, a determination of whether a corresponding time is daytime or nighttime, etc.

The local controller 130 may observe the reward 70 resulting from the proposed parameters. For example, the reward 70 may include allocated resources, an assigned throughput, etc. The local controller 130 may adjust a weight associated with the proposed parameters based on the reward 70. For example, if an allocated resource does not improve a download speed for the edge device 105, the local controller 130 may increase or decrease the weight associated with the proposed parameter to potentially increase the download speed.

The modem algorithms 142 may have many tunable parameters (or tunable arguments) that may be tuned in the field by federated learning. By adjusting (e.g., tuning) the parameters for the modem algorithms 142 by way of an API for the modem algorithms 142, the modem algorithms 142 may remain secure.

In summation, a modem algorithm 142 may be trained based on a federated learning round and based on the reinforcement model RLM to improve, for example, a download speed based on the following operations. The local controller 130 may receive data associated with the first state 62 and may receive data associated with a first reward 70. The first state 62 and the first reward 70 may be associated with the environment 60. The local controller 130 may determine (e.g., may adjust or update) one or more parameters for the modem algorithm(s) 142 based on the data associated with the first state 62 and the first reward 70. The modem algorithms 142 may generate an output based on the one or more parameters. The edge device 105 may send a resource allocation request based on the output from the modem algorithms 142. The network node 110 may provide a resource allocation based on the resource allocation request. The edge device 105 (e.g., by way of the local controller 130) may determine whether the reward 70 has increased as a result of the one or more parameters being adjusted. For example, the reward 70 may be determined based on a characteristic associated with the resource allocation (e.g., the download speed). If the download speed did not improve, the local controller 130 may again adjust one or more parameters for the modem algorithms 142 to continue the reinforcement learning process. After a time period associated with the federated learning round is complete, the edge device 105 may send data associated with the adjustments (e.g., updated weights of the controller or gradients thereof) to the server 150. The server 150 may use the data for further processing to update the global algorithm 162.

Some deep learning-based modem algorithms may be trained for corresponding channel conditions (e.g., conditions associated with pedestrians, vehicles, doppler shifts, SNR, or RF bands). In some embodiments, the final modem algorithms 142 may include an ensemble of networks trained for different channel conditions. The ensemble of networks may be combined using weighted averages as determined by tunable parameters learned by the local controller 130. In such embodiments, the tunable parameters provided by the local controller 130 may be an ensemble combining weights for a corresponding modem algorithm 142.

In some embodiments, a modem algorithm may include multiple neural networks. In such embodiments, each neural network may be trained for a corresponding received RF signal type. For example, a first neural network Network1 may be trained with data characteristics including a first signal-to-noise ratio SNR1, and an i-th network Network_i may be trained at an i-th signal-to-noise ratio SNR_i. The final output of the multiple neural networks may be the ensemble average network (e.g., Sum_i A_i*Network_i). The goal of the local controller 130, in such embodiments, may be to provide the ensemble average parameters A_i to the modem algorithm 142. For example, the ensemble average parameters A_i may correspond to the action 50 provided by the local controller 130. The modem algorithm 142 may perform with the set of ensemble average parameters A_i. After execution, based on the environment 60, the result of the action 50 may be observed (e.g., allocated throughput, localization accuracy, including alignment of Wi-Fi or Mobile-RF localization with the GPS/GNSS coordinates, error in estimating channel reference signal, etc). This result may be the reward 70. The reward 70 may be delivered to the local controller 130, along with the state 62 of the environment 60, to refine the weights of the local controller 130 based on reinforcement learning.

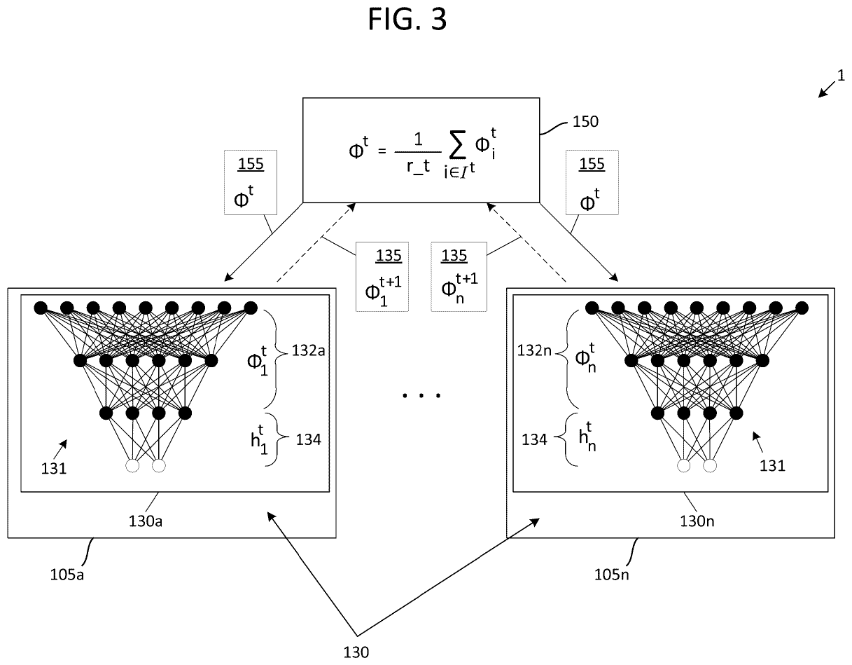

FIG. 3 is a diagram depicting portions of a neural network associated with the one or more edge devices, according to some embodiments of the present disclosure.

Referring to FIG. 3 training a local controller 130 may include extracting features from the environment 60 (see FIG. 2), and providing representations of the features. Edge devices 105 (e.g., a first edge device 105a and an n-th edge device 105n) with limited training capabilities (e.g., not having either a GPU or a specialized AI processor) may not be capable of training the whole local controller 130. In some embodiments, such edge devices 105 may only train a feature extractor 132 (e.g., a global feature extractor) at the input of the local controller 130.

In some embodiments, edge devices 105 having limited training capabilities (e.g., having only a CPU and no GPU or specialized AI processor) may be improved by training a LRR (e.g., a low-rank feature representation) of local data associated with each edge device 105. As used herein, “low-rank feature representation” refers to a machine-learning technique for reducing the complexity of input features extracted from local data for further processing by a neural network. Using a low-rank feature representation, the complexity of input features may be reduced by training a feature extractor to extract important features from the local data.

Training a low-rank feature representation may be done in a federated manner by dividing a neural network 131 associated with the local controller 130 into two network portions respectively including the feature extractor 132 located at the input of the local controller 130, and a controller head 134 (e.g., a core controller logic) of the local controller 130. The controller head 134 may be the same for each edge device 105, and may remain unchanged (e.g., may be frozen) at the edge devices 105. In such embodiments, only the weights 135 for the feature extractor 132 that are trained on the local data may be shared with the server 150. This may provide an adaptation of the feature extraction capabilities of the neural network 131 to improve the results from the local controller 130. As similarly discussed above, the server 150 may aggregate the weights 135 from respective local controllers 130 (e.g., a first local controller 130a through an n-th local controller 130n), and may determine an average (e.g., a weighted average) to aggregate the weights of the feature extractors in order to update the feature extractors 132 of each local controller 130 based on updated global-algorithm data 155.

For example, the server 150 may determine the updated global-algorithm data 155 based on calculating a weighted-average using an equation such as:

$${Φ}^{t} = \frac{1}{r\_t} {\sum }_{i ∈ {I}^{t}} {Φ}_{i}^{t} ,$$

wherein: Φ^{t} refers to a weighted average of the weights from the feature extractors 132 at a time t (the weighted average being included in the updated global-algorithm data 155); r_t refers to the number of edge devices participating in the t^{th} federated learning round, wherein the set of edge devices contributing weights for the feature extractors 132 at the t^{th} federated learning round is denoted by I^{t}, and i ∈ I^{t} refers to the index of edge devices contributing feature-extractor weights at the time t. The weighted average of the weights from a first feature extractor 132a through an n-th feature extractor 132n may be calculated again at a time t+1.

In some embodiments, the system 1 may train the full local controllers 130 (e.g., the feature extractor 132 and the controller head 134) of the edge devices 105 having full training capabilities, and of the edge devices 105 having limited training capabilities. In such embodiments, the server 150 may receive full weights (or gradients thereof) from the edge devices 105 having full training capabilities. The server 150 may also receive weights (or gradients thereof) for only the feature extractors 132 from the edge devices 105 having limited training capabilities. The server 150 may aggregate the weights (or gradients thereof) (also referred to as “updates”) from both types of the edge devices 105. For example, the server 150 may aggregate feature-extraction weights from all edge devices 105 (e.g., all selected edge devices 105) and aggregate the controller-head weights from the edge devices 105 having full training capabilities. The server 150 may share updates for the full local controller 130 (e.g., both the feature extractor 132 and the controller head 134) with all edge devices 105 (e.g., all selected edge devices 105).

In some embodiments, the system 1 may train pre-trained feature extractors of edge devices 105 having no training capabilities by sharing anonymous extracted and encrypted features from the edge devices 105, which have no training capabilities, with the server 150. In such embodiments, the system 1 may perform feature-based federated learning over a time window (e.g., a time window that is relatively long) using secure aggregation or operations related to federated learning using singular vector decomposition (SVD) to further reduce the communication and computation costs of federated learning. Such feature-based federated learning is referred to herein as “Reduced-Fed.”.

For example, in a first operation of Reduced-Fed, each user may mask their data based on a global masking matrix broadcast to all users and based on a user masking vector generated by the server 150. The user, as opposed to the server 150, may run SVD. The user may share a low rank anonymous vector with the server 150. The server 150 may train the global controller 160 (see FIG. 1) based on aggregated features received from different users, and may share the weights of the global controller 160 with the edge devices 105 on a secure network. By not sharing the modem algorithms 142 (e.g., by keeping the modem algorithms 142 private), the security of the modem algorithms 142 may be maintained. The updated global controller 160 may be used to adapt the pre-trained modem algorithms 142 (secured on the edge devices 105) by adjusting the tunable parameters of the modem algorithms 142. For example, the tunable parameters may be adjusted based on the channel type, RF-band, and location signals for operating the edge devices 105.

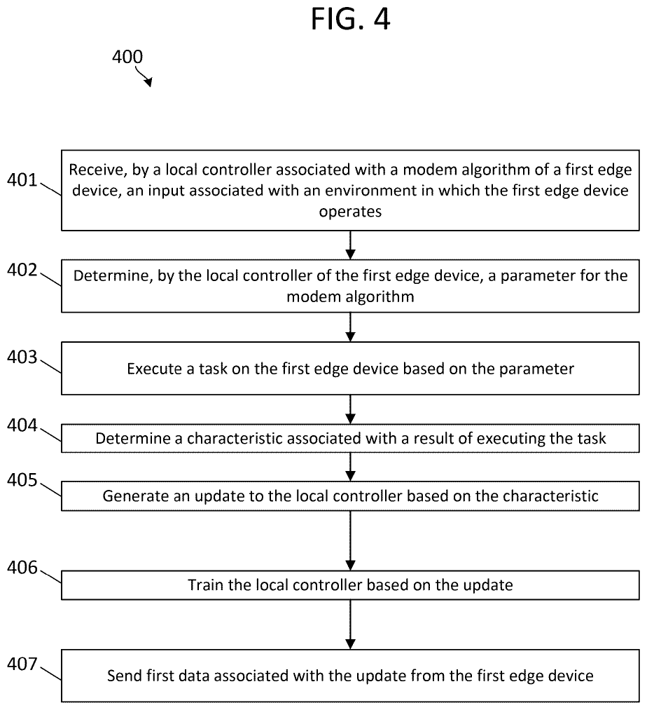

FIG. 4 is a flowchart depicting example operations of a method for training the modem algorithm, according to some embodiments of the present disclosure. However, the present disclosure is not limited to the sequence or number of the operations of the method 400 shown in FIG. 4, and can be altered into any desired sequence or number of operations as recognized by a person having ordinary skill in the art. For example, in some embodiments, the order may vary, some processes thereof may be performed concurrently or sequentially, or the method 400 may include fewer or additional operations.

Referring to FIG. 4, a method 400 for training the modem algorithm may include one or more of the following operations. A local controller 130 associated with a modem algorithm 142 of a first edge device 105 may receive an input associated with an environment in which the first edge device 105 operates (operation 401). The local controller 130 may determine one or more parameters for the modem algorithm 142 of the edge device 105 (operation 402). The modem algorithm 142 may execute (e.g., may perform) a task on the first edge device based on the parameter (operation 403). In some embodiments the task may include a resource allocation task (e.g., sending a resource allocation request). In some embodiments, the task may include performing a localization-related task. In some embodiments, the task may include a computer vision task (e.g., channel decoding for computer vision). The edge device 105 may determine a characteristic associated with a result of executing the task (operation 404). The edge device 105 may generate an update to the local controller 130 based on the characteristic (operation 405). The edge device 105 may train the local controller 130 based on the update (operation 406). The edge device 105 may send data associated with the update to a server 150 (operation 407).

FIG. 5 is a block diagram of an electronic device in a network environment, according to some embodiments of the present disclosure.

Referring to FIG. 5, an electronic device 501 in a network environment 500 may communicate with an electronic device 502 via a first network 598 (e.g., a short-range wireless communication network), or with an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 540, a sound output device 555, a display device 560, an audio module 570, a sensor module 576, an interface 577, a haptic module 579, a camera module 580, a power management module 588, a battery 589, a communication module 590, a subscriber identification module (SIM) card 596, and/or an antenna module 597. In one embodiment, at least one of the components (e.g., the display device 560 or the camera module 580) may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled to the processor 520, and may perform various data processing or computations.

As at least part of the data processing or computations, the processor 520 may load a command or data received from another component (e.g., the sensor module 576 or the communication module 590) in volatile memory 532, may process the command or the data stored in the volatile memory 532, and may store resulting data in non-volatile memory 534. The processor 520 may include a main processor 521 (e.g., a CPU or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or to execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590), as opposed to the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as separate from, or as a part of, the speaker.

The display device 560 may visually provide information to the outside (e.g., to a user) of the electronic device 501. The display device 560 may include, for example, a display, a hologram device, or a projector, and may include control circuitry to control a corresponding one of the display, hologram device, and projector. The display device 560 may include touch circuitry adapted to detect a touch, or may include sensor circuitry (e.g., a pressure sensor) adapted to measure the intensity of force incurred by the touch.

The audio module 570 may convert a sound into an electrical signal and vice versa. The audio module 570 may obtain the sound via the input device 550 or may output the sound via the sound output device 555 or a headphone of an external electronic device 502 directly (e.g., wired) or wirelessly coupled to the electronic device 501.

The sensor module 576 may detect an operational state (e.g., power or temperature) of the electronic device 501, or an environmental state (e.g., a state of a user) external to the electronic device 501. The sensor module 576 may then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 577 may support one or more specified protocols to be used for the electronic device 501 to be coupled to the external electronic device 502 directly (e.g., wired) or wirelessly. The interface 577 may include, for example, a high-definition multimedia interface (HDMI), a universal serial bus (USB) interface, a secure digital (SD) card interface, or an audio interface.

A connecting terminal 578 may include a connector via which the electronic device 501 may be physically connected to the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus, which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power that is supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell that is not rechargeable, a secondary cell that is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508), and may support performing communication via the established communication channel. The communication module 590 may include one or more communication processors that are operable independently from the processor 520 (e.g., the AP), and may support a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, or a standard of the Infrared Data Association (IrDA)), or via the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas. The communication module 590 (e.g., the wireless communication module 592) may select at least one of the one or more antennas appropriate for a communication scheme used in the communication network, such as the first network 598 or the second network 599. The signal or the power may then be transmitted or received between the communication module 590 and the external electronic device via the selected at least one antenna.

Commands or data may be transmitted or received between the electronic device 501 and the external electronic device 504 via the server 508 coupled to the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims, with functional equivalents thereof to be included therein.

What is claimed is:

1. A method comprising:
receiving, by a first local controller of a first edge device, an input associated with an environment in which the first edge device operates;
using a first machine-learning algorithm, determining, by the first local controller, a parameter for a pre-trained modem algorithm of the first edge device based on the input;
executing a task on the first edge device based on executing the pre-trained modem algorithm with the parameter;
determining a result of executing the task;
training the first machine-learning algorithm, based on the task and the result of executing the task;
generating a first update to the first machine-learning algorithm based on the training;
sending the first update to an external server;
receiving, from the external server, a server update to the first machine-learning algorithm, wherein the server update is created, by the external server, using at least one of the first update and a second update from a second local controller of a second edge device; and
based on the server update, updating the first machine-learning algorithm.

2. The method of claim 1, wherein the task comprises sending a resource allocation request from the first edge device to a base station.

3. The method of claim 1, wherein the input comprises a channel estimate.

4. The method of claim 1, wherein:
the first edge device comprises a processing circuit comprising a central processing unit (CPU);
the training comprises updating a first feature extractor associated with the first local controller; and
sending the first update comprises sending an update associated with the first feature extractor.

5. The method of claim 1, wherein:
the first edge device comprises a processing circuit comprising an artificial intelligence (AI) processor;
the training comprises updating a first controller logic associated with the first local controller; and
sending the first update comprises sending an update associated with the first controller logic.

6. The method of claim 1, wherein server update is created by:
receiving, by the external server, the first update and the second update;
generating aggregated data based on the first update and the second update; and
updating a global algorithm associated with a global controller based on the aggregated data.

7. The method of claim 1, wherein the updating of the first machine-learning algorithm comprises updating at least one of a first feature extractor or a first controller logic.

8. A first device comprising a processing circuit comprising:
a first local controller; and
a pre-trained modem algorithm communicatively coupled to the first local controller,
wherein the processing circuit is configured to:
receive an input associated with an environment in which the first device operates;
use a first machine-learning algorithm to determine a parameter for the pre-trained modem algorithm based on the input;
execute a task on the first device based on executing the pre-trained modem algorithm with the parameter;
determine a result of executing the task;
train the first machine-learning algorithm, based on the task and the result of executing the task;
generate a first update to the first machine-learning algorithm based on the training;
send the first update to an external server;
receive, from the external server, a server update to the first machine-learning algorithm, wherein the server update is created, by the external server, using at least one of the first update and a second update from a second local controller of a second device; and
based on the server update, update the first machine-learning algorithm.

9. The first device of claim 8, wherein the task comprises sending a resource allocation request from the first device to a base station.

10. The first device of claim 8, wherein the input comprises a channel estimate.

11. The first device of claim 8, wherein:
the processing circuit comprises a central processing unit (CPU);
the processing circuit is configured to train the first local controller by updating a first feature extractor associated with the processing circuit; and
the sending of the first update comprises sending an update associated with the first feature extractor.

12. The first device of claim 8, wherein:
the processing circuit comprises an artificial intelligence (AI) processor;
the processing circuit is configured to train the first local controller by updating a first controller logic associated with the processing circuit; and
the sending of the first update comprises sending an update associated with the first controller logic.

13. The first device of claim 8, wherein the server update is created by:
receiving, by the external server, the first update and the second update;
generating aggregated data based on the first update and the second update; and
updating a global algorithm associated with a global controller based on the aggregated data.

14. The first device of claim 8, wherein the updating of the first machine-learning algorithm comprises updating at least one of a first feature extractor or a first controller logic.

15. A system comprising a first edge device comprising:
a processing circuit; and
a memory for storing instructions, which, based on being executed by the processing circuit, cause the processing circuit to:
receive an input associated with an environment in which the first edge device operates;
use a first machine-learning algorithm to determine a parameter for a pre-trained modem algorithm based on the input;
execute a task on the first edge device based on executing the pre-trained modem algorithm with the parameter;
determine a result of executing the task;
train the first machine-learning algorithm, based on the task and the result of executing the task;
generate a first update to the first machine-learning algorithm based on the training;
send the first update to an external server;
receive, from the external server, a server update to the first machine-learning algorithm, wherein the server update is created, by the external server, using at least one of the first update and a second update from a second edge device; and
based on the server update, update the first machine-learning algorithm.

16. The system of claim 15, wherein the task comprises sending a resource allocation request from the first edge device to a base station.

17. The system of claim 15, wherein the input comprises a channel estimate.

18. The system of claim 15, wherein:
the processing circuit comprises a central processing unit (CPU);
the processing circuit is configured to train a local controller of the first edge device by updating a first feature extractor associated with the processing circuit; and
the sending of the first update comprises sending an update associated with the first feature extractor.

19. The system of claim 15, wherein:
the processing circuit comprises an artificial intelligence (AI) processor;
the processing circuit is configured to train a local controller of the first edge device by updating a first controller logic associated with the processing circuit; and
the sending of the first update comprises sending an update associated with the first controller logic.

20. The system of claim 15, wherein updating of the first machine-learning algorithm comprises updating at least one of a first feature extractor or a first controller logic.
